(19) United States
(12) Patent Application Publication
(10) Pub. No.: US 2024/0356292 A1
(43) Pub. Date: Oct. 24, 2024

(54) POWERED ADAPTOR FOR VIEWING DEVICE

(71) Applicant: WILCOX INDUSTRIES CORP., Newington, NH (US)

(72) Inventors: James W. Teetzel, Portsmouth, NH (US); Elliott S. Turner, Newmarket, NH (US); Patrick K. Graham, Kittery, ME (US)

(21) Appl. No.: 18/636,511

(22) Filed: Apr. 16, 2024

Related U.S. Application Data
(60) Provisional application No. 63/461,123, filed on Apr. 21, 2023.

(51) Int. Cl. H01R 31/06; A42B 3/04; G02B 23/12; H01R 13/53; H01R 13/622

(52) U.S. Cl. CPC H01R 31/065; A42B 3/042; G02B 23/125; H01R 13/53; H01R 13/622

(57) ABSTRACT

A powered helmet mount adaptor for a helmet-mounted viewing device includes a hot shoe assembly configured to replace an existing mounting adaptor on the helmet-mounted viewing device. The hot shoe assembly has a plurality of electrical contacts which are structured and operable to receive power via a receiver on an associated helmet mount assembly. A power cable integral with the hot shoe assembly has a first end integral with the hot shoe assembly and a second end opposite the first end. The second end has a connector configured to mate with a power inlet on the helmet-mounted viewing device. In another aspect, a method of replacing a mounting shoe of a viewing device with a powered helmet mount adaptor is provided.

### CROSS REFERENCE TO RELATED APPLICATION

This application claims the priority benefit of U.S. provisional application No. 63/461,123 filed Apr. 21, 2023. The aforementioned application is incorporated herein by reference in its entirety.

### BACKGROUND

The present invention relates to a powered adaptor for a helmet-mounted viewing device. Although the invention will be described herein primarily by way of reference to a powered adaptor for a night vision binocular device, it will be recognized that the powered adaptor herein may also be used in connection with other helmet-mounted viewing devices including cameras, thermal cameras, head up displays (HUDs), augmented reality (AR) displays, virtual reality (VR) headsets, and others.

Helmets used for military personnel, emergency responders, and others often include one or more brackets or other mounting apparatus to allow one or more accessories to be detachably coupled to the helmet. Powered accessories, such as night vision devices (NVDs) or night vision goggles (NVGs) are often used for personnel operating in low light conditions. Commonly, night vision devices include an internal power supply as well as a power connector for electrically coupling to an external power source to provide a redundancy of power supplies. It is also common for night vision devices to include a mounting shoe for attachment of a night vision device to a shoe receiver on a helmet mount assembly on the front of a helmet, which provides a mechanical attachment of the night vision device to the helmet. A cable extending between the electrical connector on the night vision device and an external battery pack provides an electrical coupling between the night vision device and the external battery pack.

In some helmet systems a power supply is provided on the helmet and is electrically coupled to a powered shoe receiver on a helmet mount assembly. In such cases, the use of a dedicated external battery pack for the night vision device increases the number of components a user is required to carry and adds undesirable weight. In addition, the cable used to electrically couple the night vision device can be lengthy and cumbersome to use depending on where the user elects to position the battery pack. The present disclosure contemplates a new and improved mounting powered shoe adapter for both mechanical and electrical coupling of a night vision device to a powered shoe receiver of a front helmet mount assembly, which avoids the need for a dedicated night vision device battery pack and the associated weight and a potentially unwieldy cable.

### SUMMARY

In one aspect, a powered helmet mount adaptor for a helmet-mounted viewing device includes a hot shoe assembly configured to replace an existing mounting adaptor on the helmet-mounted viewing device. The hot shoe assembly has a plurality of electrical contacts which are structured and operable to receive power via a receiver on an associated helmet mount assembly. A power cable integral with the hot shoe assembly has a first end integral with the hot shoe assembly and a second end opposite the first end. The second end has a connector configured to mate with a power inlet on the helmet-mounted viewing device. In another aspect, a method of replacing a mounting shoe of a viewing device with a powered helmet mount adaptor is provided.

In a more limited aspect, a powered helmet mount adaptor for night vision device includes a hot shoe housing base and a hot shoe housing cover. The hot shoe housing base includes a central clearance opening for receiving a threaded fastener which engages a tapped opening on the night vision device. The shoe housing cover is secured to the hot shoe housing base and includes a terminal block with contacts configured to align with corresponding contacts within a mounting shoe receiver on a helmet mount assembly. A plurality of conductors extends within a cable between the housing cover and a plug for electrically engaging a complementary socket on the night vision device.

In another more limited aspect, the hot shoe assembly includes a hot shoe housing base secured to a hot shoe housing cover. A terminal block intermediate the hot shoe housing base and the hot shoe housing cover has the plurality of electrical contacts thereon, the plurality of electrical contacts configured to electrically couple with aligned electrical contacts on the receiver.

In another more limited aspect, the hot shoe housing base includes a clearance opening configured to receive a threaded fastener for securing the hot shoe assembly to viewing device.

In another more limited aspect, the hot shoe assembly includes one or more threaded fasteners securing the hot shoe housing cover to the hot shoe housing base.

In another more limited aspect, the hot shoe housing base has (a) a base lower surface configured to face toward the night vision device; (b) a base upper surface opposite the base lower surface; and (c) a groove in the base upper surface. The hot shoe housing cover has (a) a cover lower surface facing the base upper surface; (b) a cover upper surface opposite the cover lower surface; and (c) a notch formed in the cover lower surface, wherein the groove and the notch cooperate to define a passageway for the cable.

In another more limited aspect, the hot shoe housing base and the hot shoe housing cover cooperate to define a cavity for receiving material to secure the plurality of electrical contact and seal against entry of moisture and/or other environmental contaminants into the cavity.

In another more limited aspect, the connector is a plug connector.

In another more limited aspect, the connector is a 3 or 4 pin Fischer or Fischer-compatible binocular night vision plug connector.

In another more limited aspect, the hot shoe assembly includes one or more alignment pins configured to engage a respective one or more alignment openings on the on the viewing device for aligning the powered mounting adaptor in relation to the viewing device.

In another more limited aspect, the viewing device is a binocular viewing device including first and second monocular devices and wherein the cable includes a first set of conductors for powering the first monocular device and a second set of conductors for powering the second monocular device.

In another more limited aspect, the hot shoe assembly includes one or more lips extending from the housing cover configured to facilitate detachable engagement with the hot shoe receiver.

In another more limited aspect, a night vision assembly includes the powered mounting adaptor herein in combination with the viewing device.

In another more limited aspect, the viewing device includes first and second night vision assemblies, each of the first and second night vision assemblies including an image intensifier tube assembly, an eyepiece lens assembly, and an objective lens assembly. A central bridge assembly is coupled to the powered mounting adaptor and connects the first and second night vision assemblies. The power connector inlet is disposed on the central bridge assembly and is configured to provide an electrical interface for supplying operational power to the first and second night vision assemblies.

In another more limited aspect, the viewing device is a night vision binocular device.

In another more limited aspect, the viewing device is an AN/PVS-31A night vision binocular device.

In another aspect, a kit of components usable together includes the night vision assembly and a helmet mount assembly attachable to a helmet and configured to detachably couple to the powered mounting adaptor.

In another aspect, a method for replacing a mounting shoe of a helmet-mounted viewing device having a power inlet with a powered helmet mount adaptor includes the steps of removing a fastener securing the mounting shoe to a fastener element on the viewing device and providing a powered helmet mount adaptor. The powered helmet mount adaptor includes (a) a hot shoe assembly having a plurality of electrical contacts structured and operable to receive power via a receiver on an associated helmet mount assembly and; (b) a power cable integral with the hot shoe assembly, the power cable having a first end integral with the hot shoe assembly and a second end opposite the first end, the second end having a connector configured to mate with the power inlet. The hot shoe assembly is secured to the viewing device in place of the mounting shoe using the fastener or a like fastener and the fastener element and the connector is attached to the power inlet.

In a more limited aspect, the hot shoe assembly includes a hot shoe housing base secured to a hot shoe housing cover and a terminal block intermediate the hot shoe housing base and the hot shoe housing cover. The terminal block has a plurality of electrical contacts thereon, which are configured to electrically couple with aligned electrical contacts on the receiver. When securing the hot shoe assembly to the viewing device, the hot shoe housing base is first secured to the viewing device using the fastener or a like fastener and the fastener element and then securing the hot shoe housing cover to the hot shoe base.

In another more limited aspect, the viewing device is a night vision binocular device.

In another more limited aspect, the viewing device is an AN/PVS-31A night vision binocular device.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a top view of a powered adaptor for a night vision device in accordance with an exemplary embodiment.

FIG. 2 is a bottom view of the powered adaptor appearing in FIG. 1.

FIG. 3 is a bottom view of the powered adaptor appearing in FIG. 1, with the base member of the hot shoe assembly removed for ease of exposition.

FIG. 4 is an isometric view of the powered adaptor appearing in FIG. 1, taken generally from the bottom.

FIG. 5 is an isometric view of the powered adaptor appearing in FIG. 1, taken generally from the top.

FIG. 6 is an exploded isometric view of the powered adaptor appearing in FIG. 1.

FIG. 7 illustrates an exemplary night vision device and the manner of exchanging the existing mechanical mounting shoe on the night vision device with the powered adaptor appearing in FIG. 1.

FIG. 8 is a block diagram of the view of the powered adaptor system herein.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

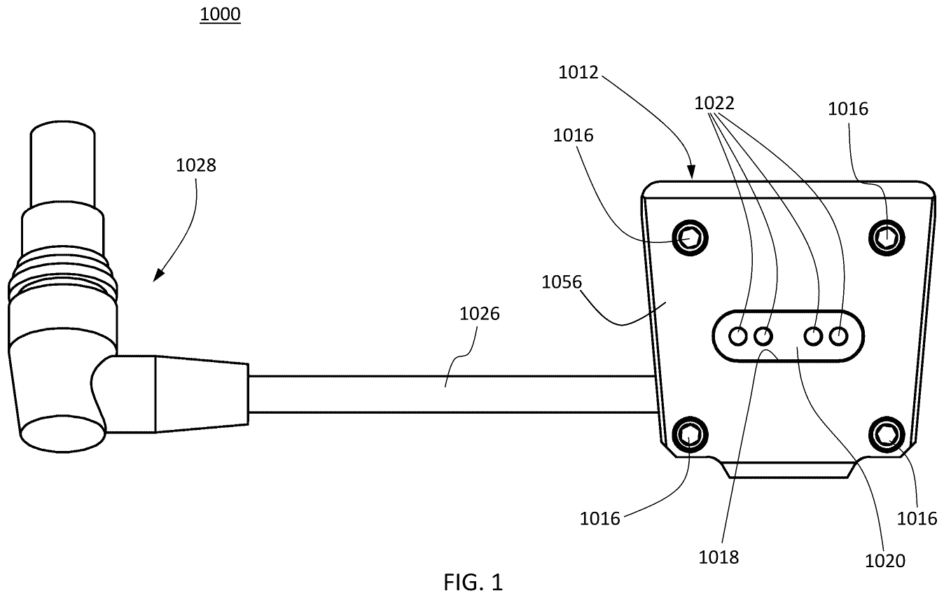

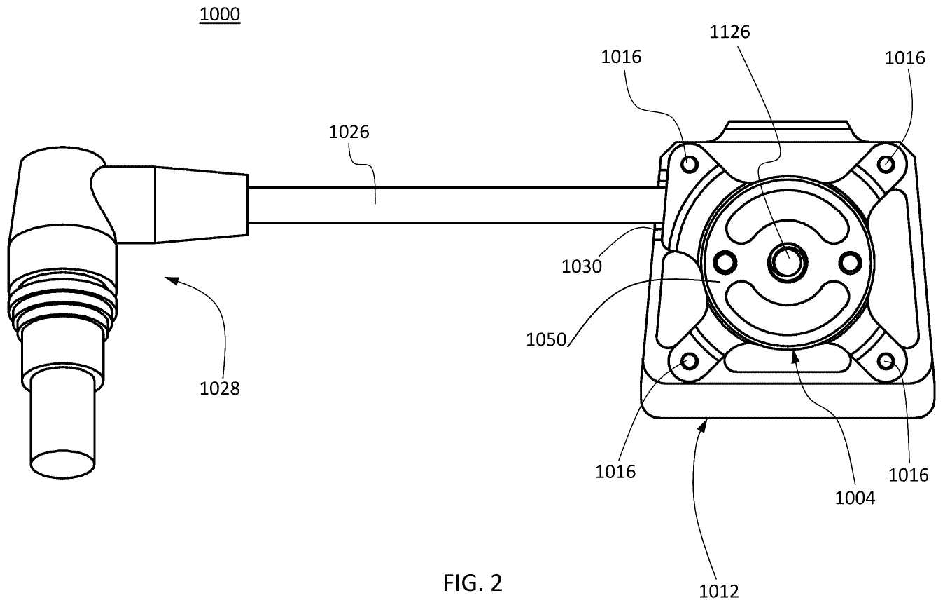

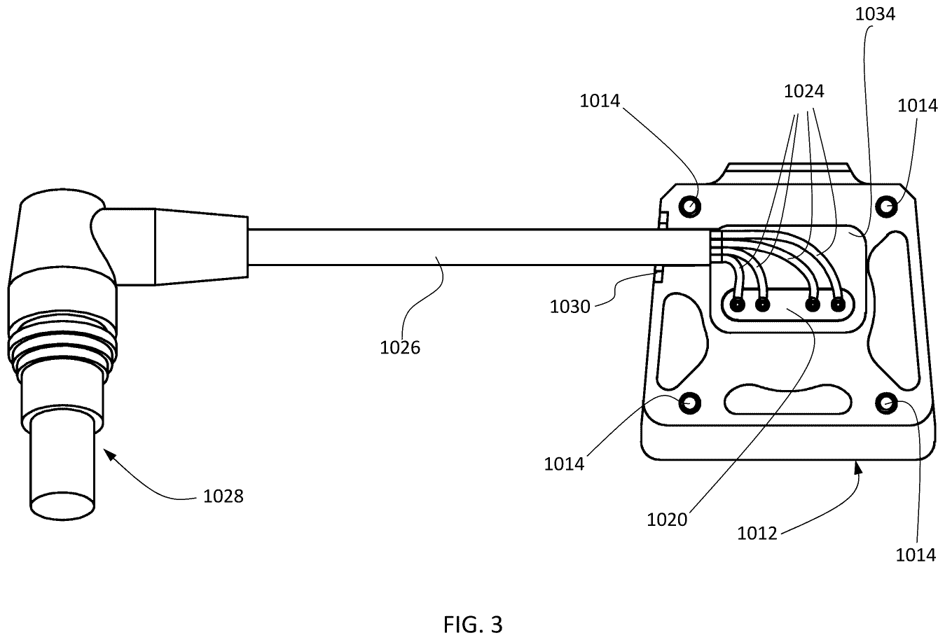

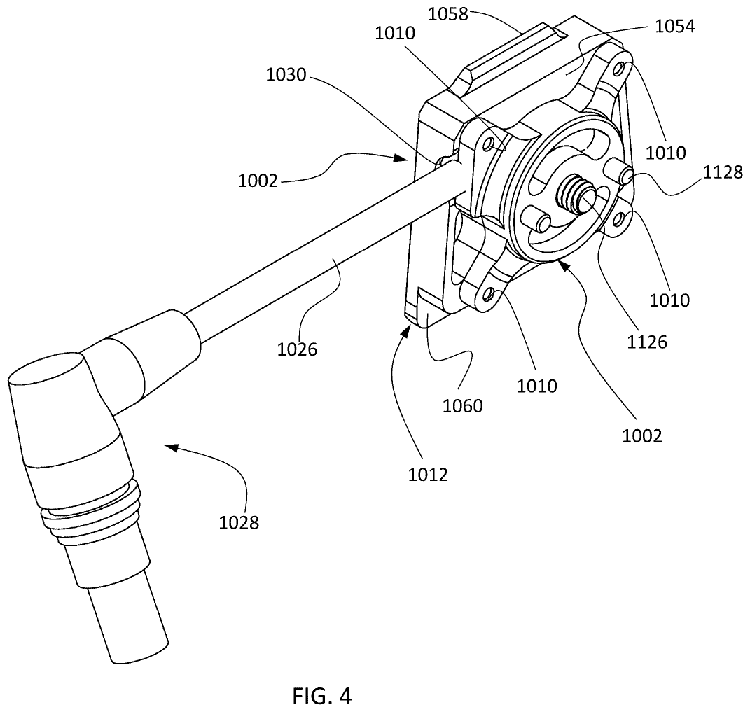

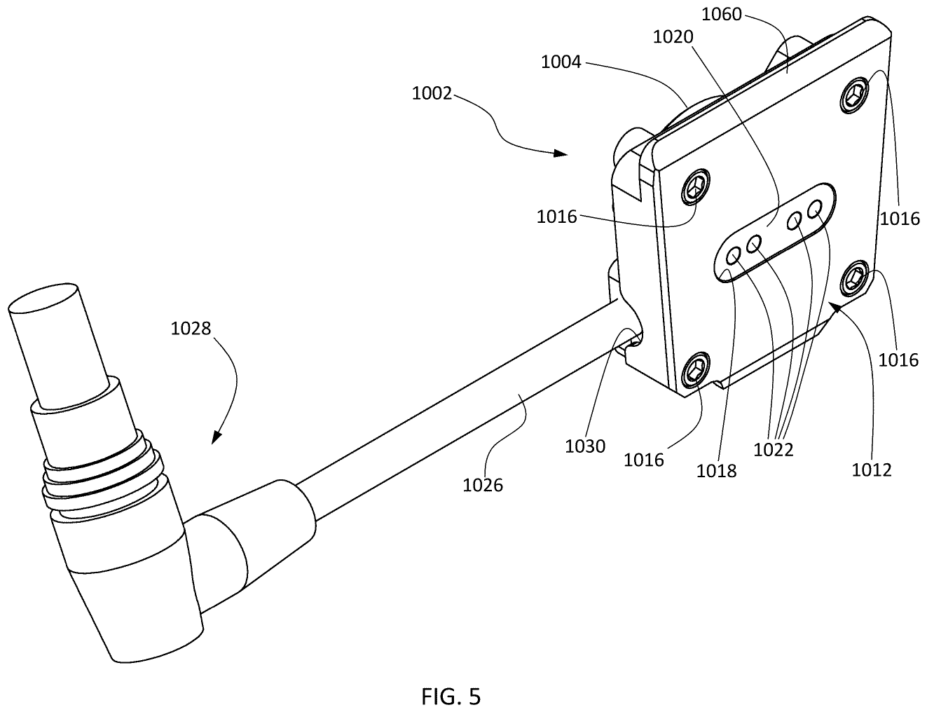

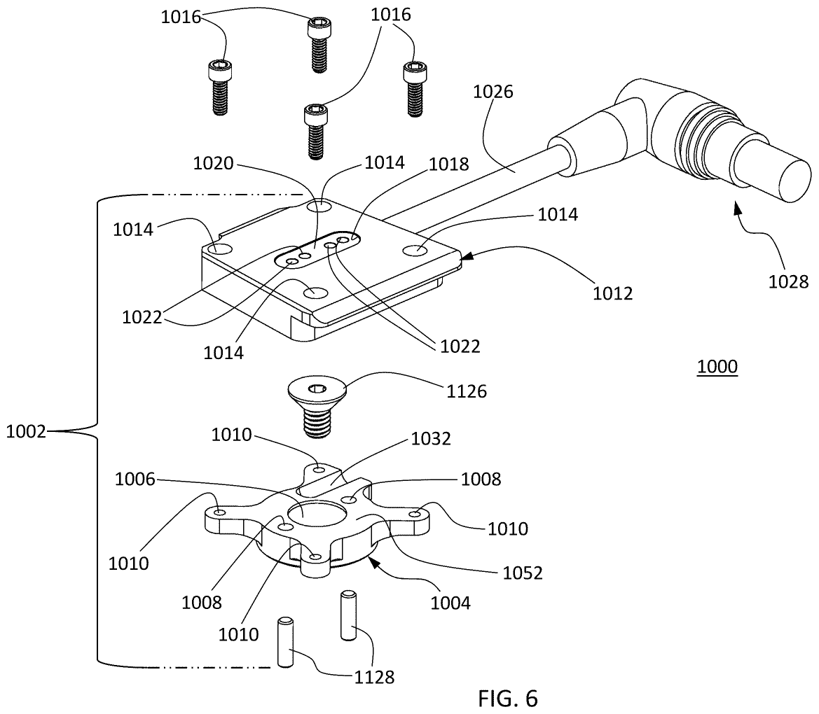

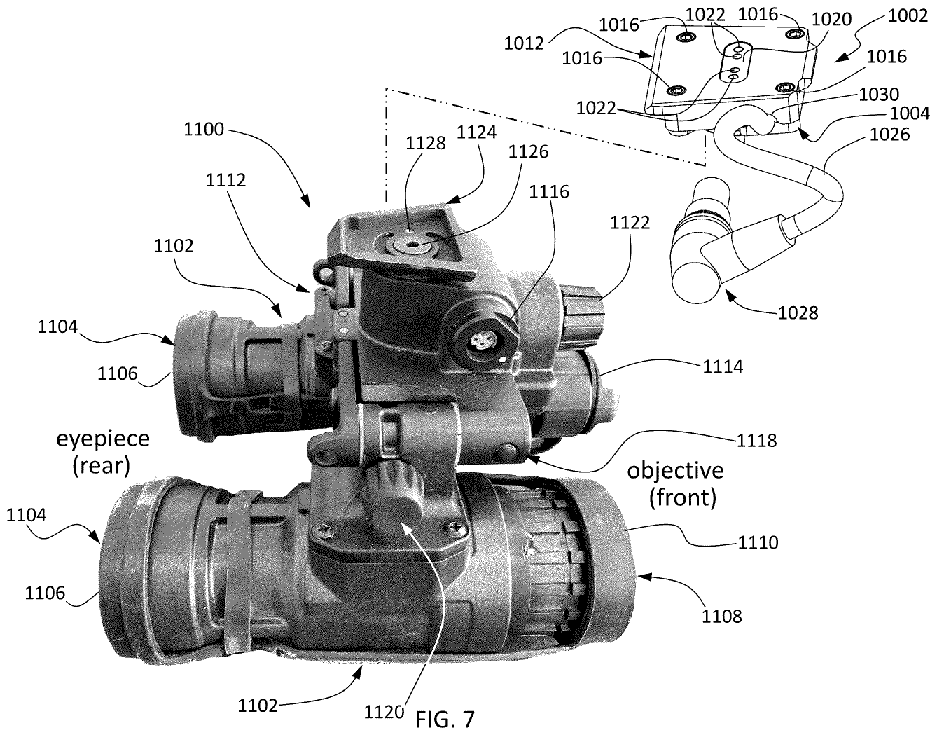

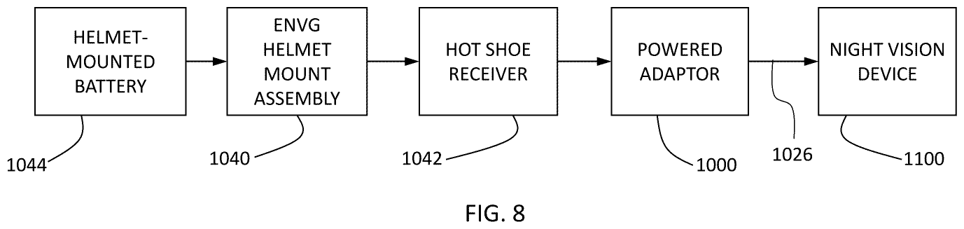

Referring now to FIGS. 1-8, an exemplary embodiment is illustrated wherein a powered mounting adaptor for night vision device 1000 is configured as a replacement mounting shoe for a night vision device 1100. In the depicted embodiment, the powered adaptor 1000 is configured for use with a Binocular Night Vision Device (BNVD) available from L3Harris Technologies, Inc. (Melbourne, Florida, USA). In embodiments, the night vision device 1100 is an AN/PVS-31A night vision device available from L3Harris Technologies, Inc. It will be recognized that the powered adaptor 1000 could be adapted for use with other night vision devices.

The night vision device 1100 includes left and right image intensifier tube assemblies 1102, left and right eyepiece lens assemblies 1104 with lens covers 1106, and left and right objective lens assemblies 1108 with lens covers 1110. The image intensifier tube assemblies 1102 are coupled to a central bridge assembly 1112 with a battery compartment (not shown) housing an internal battery(ies) and a battery compartment cover 1114. A power connector 1116 is disposed on the central bridge assembly 1112 to provide a cabled attachment to an external battery pack (not shown) associated with the night vision device 1100. In the illustrated embodiment, the power connector 1116 is a Fischer BNVD 3 or 4-pin socket or Fischer-style or Fischer-compatible BNVD 3 or 4-pin sockets which emulates the design and functionality of such connectors manufactured by Fischer, which is configured to receive and engage a Fischer, or Fischer-style or Fischer-compatible, plug connector. The power connector 1116 includes a plurality of contact elements disposed within a receptacle which are configured to establish electrical contact with corresponding pins of a Fischer, or Fischer-style or Fischer-compatible, plug 1028 to establish an electrical connection between the hot shoe assembly 1002 and the night vision device 1100.

The central bridge assembly 1112 includes pivot hinge assemblies 1118. Adjustment knobs 1120 allow the user to set a desired interpupillary distance. A manual gain control 1122 allows the user to adjust a gain or brightness of the image intensifier tube assemblies 1102.

The central bridge assembly 1112 further includes a dovetail or trapezoidal mounting shoe 1124 for attachment to a helmet or headgear mounting assembly 1040. The mounting shoe 1124 is secured with a threaded fastener 1126 engaging a tapped opening (not shown) in the central bridge assembly 1112 and is indexed using alignment pins 1128.

The powered adaptor 1000 includes a hot shoe assembly 1002, which is configured for releasable attachment to a helmet mount assembly 1040 of a type having a powered hot shoe receiver 1042 which is configured for use with an enhanced night vision device of a type utilizing image intensification and thermal imaging technologies. In embodiments, the helmet mount assembly 1040 and powered hot shoe receiver 1042 are of a type designed to be compatible with Enhanced Night Vision Goggle-Binoculars (ENVG-B), such as the L3Harris Technologies ENVG-B. In certain embodiments, the helmet mount assembly 1040 is a Universal Helmet Mount Assembly (UHMA) configured for use with the ENVG-B. In this manner, a conventional night vision binocular device, e.g., using image intensifying technology such as an L3Harris BNVD (e.g., AN/PVS-31A), can be adapted to be forward compatible with an ENVG positioning assembly, such as a Universal Helmet Mount Assembly.

The hot shoe assembly 1002 includes a hot shoe housing base 1004 and a hot shoe housing cover 1012. The base includes a central clearance opening 1006 which receives the threaded fastener 1126 for engaging the tapped opening (not shown) in the central bridge assembly 1112. The alignment pins 1128 engage pin receiving openings 1008 in the base 1004 as well as aligned complementary openings in the central bridge assembly 1112. Four base tapped openings 1010 are disposed at the corners of the base 1004. The base 1004 includes a base lower surface 1050 that faces the night vision device 1100 and a base upper surface 1052 opposite from the base lower surface 1050. A groove 1032 is formed in the upper surface 1052 of the base 1004.

The shoe housing cover 1012 includes four cover clearance openings 1014 disposed at the corners, which are aligned with the four tapped openings 1010 in the base 1004. Four threaded fasteners 1016 pass through the clearance openings 1014 and engage the respective tapped openings 1010 in the base 1004. In embodiments, the shoe housing cover 1012 includes one or more features to facilitate secure and detachable engagement with a complementary hot shoe receiver, such as a lips or ledges 1058 and 1060 that extend from the housing cover 1012. The shoe housing cover 1012 includes a cover lower surface 1054 that faces the base upper surface 1052 and a cover upper surface 1056 opposite from the cover lower surface 1054.

A cover central opening 1018 receives a terminal block 1020 having power and ground electrical contacts 1022. Conductors 1024 within a cable 1026 are attached to each contact 1022 and are electrically coupled to respective pins in a plug connector 1028. The contacts 1022 are positioned so that they align with a corresponding electrical contact on a mounting shoe received on a helmet mount assembly 1040. The helmet mount assembly 1040 includes a powered hot shoe receiver 1042, which is configured to be electrically coupled to a battery 1044 such as a helmet mounted battery via a cable. In the illustrated embodiment, the plug connector 1028 is a Fischer, or Fischer-style/Fischer-compatible, BNVD 3 or 4-pin plug connector. The housing cover 1012 includes a notch 1030 which cooperates with the groove 1032 to provide a passageway for the cable 1026. By integrating the cable 1026 with the hot shoe assembly 1002, the cable 1026 can be sized only as necessary to extend between the hot shoe assembly 1002 and the power inlet 1116 on the night vision device 1100 and excess cable length can be reduced or eliminated. thereby reducing unnecessary cable clutter in the helmet system and reducing the risk of entanglement. In embodiments, the cover lower surface 1054 of the housing cover 1012 includes a cavity or recess 1034 for receiving a potting material, such as a polymer resin. for securing the contact points and scaling against entry of moisture or other environmental contamination.

In operation, to replace the mechanical shoe 1124 of the night vision device 1100, the threaded fastener 1126 is removed to remove the mechanical shoe 1124 from the central bridge assembly 1112. Next, the base member 1004 is secured to the central bridge assembly 1112 in place of the mechanical shoe 1124 by passing the threaded fastener 1126 through the central opening 1006 and threadably engaging the tapped opening (not shown) in the central bridge assembly 1112. The shoe housing cover 1012 is then secured to the base member 1004 using the threaded fasteners 1016 by passing them through the respective clearance opening 1014 and threadably engaging the respective tapped openings 1010 in the base member 1004. Finally, the connector plug 1028 is plugged into the connector socket 1116 on the central bridge assembly 1112. In this manner, the night vision device 1100 can be adapted for use with the helmet mount assembly 1040 and receive power from the helmet mounted battery 1044 using the powered adaptor 1000 without the need for a dedicated external battery to power the night vision device 1100.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A powered helmet mount adaptor for powering a helmet-mounted viewing device, the adaptor comprising:
a hot shoe assembly configured to replace an existing mounting adaptor on the helmet-mounted viewing device, the hot shoe assembly having a plurality of electrical contacts structured and operable to receive power via a receiver on an associated helmet mount assembly; and
a power cable integral with the hot shoe assembly, the power cable having a first end integral with the hot shoe assembly and a second end opposite the first end, the second end having a connector configured to mate with a power inlet on the helmet-mounted viewing device.

2. The powered mounting adaptor of claim 1, wherein the hot shoe assembly comprises:
a hot shoe housing base secured to a hot shoe housing cover;
a terminal block intermediate said hot shoe housing base and said hot shoe housing cover, said terminal block having said plurality of electrical contacts thereon, said plurality of electrical contacts configured to electrically couple with aligned electrical contacts on the receiver.

3. The powered mounting adaptor of claim 2, wherein said hot shoe housing base includes a clearance opening configured to receive a threaded fastener for securing the hot shoe assembly to viewing device.

4. The powered mounting adaptor of claim 3, wherein said hot shoe assembly includes one or more threaded fasteners securing the hot shoe housing cover to the hot shoe housing base.

5. The powered mounting adaptor of claim 2, further comprising:
said hot shoe housing base having (a) a base lower surface configured to face toward the night vision device; (b) a base upper surface opposite said base lower surface; and (c) a groove in said base upper surface; and
said hot shoe housing cover having (a) a cover lower surface facing said base upper surface; (b) a cover upper surface opposite said cover lower surface; and (c) a notch formed in said cover lower surface;
wherein said groove and said notch cooperate to define a passageway for said cable.

6. The powered mounting adaptor of claim 2, wherein said hot shoe housing base and said hot shoe housing cover cooperate to define a cavity for receiving material to secure said plurality of electrical contact and seal against entry of moisture and/or other environmental contaminants into said cavity.

7. The powered mounting adaptor of claim 1, wherein said connector is a plug connector.

8. The powered mounting adaptor of claim 1, wherein said connector is a 3 or 4 pin Fischer or Fischer-compatible binocular night vision plug connector.

9. The powered mounting adaptor of claim 1, wherein said hot shoe assembly includes one or more alignment pins configured to engage a respective one or more alignment openings on the on the viewing device for aligning the powered mounting adaptor in relation to the viewing device.

10. The powered mounting adaptor of claim 1, wherein the viewing device is a binocular viewing device comprising first and second monocular devices and wherein said cable includes a first set of conductors for powering the first monocular device and a second set of conductors for powering the second monocular device.

11. The powered mounting adaptor of claim 1, wherein said hot shoe assembly includes one or more lips extending from said housing cover configured to facilitate detachable engagement with the hot shoe receiver.

12. A night vision assembly comprising the powered mounting adaptor of claim 1 in combination with the viewing device.

13. A night vision assembly of claim 12, wherein the viewing device comprises:
first and second night vision assemblies, each of the first and second night vision assemblies comprising an image intensifier tube assembly, an eyepiece lens assembly, and an objective lens assembly;
a central bridge assembly coupled to the powered mounting adaptor and connecting the first and second night vision assemblies; and
the power connector inlet disposed on the central bridge assembly and configured to provide an electrical interface for supplying operational power to the first and second night vision assemblies.

14. The night vision assembly of claim 12, wherein the viewing device is a night vision binocular device.

15. The night vision assembly of claim 14, wherein the viewing device is an AN/PVS-31A night vision binocular device.

16. A kit of components usable together, the kit comprising:
the night vision assembly of claim 12; and
a helmet mount assembly attachable to a helmet and configured to detachably couple to said powered mounting adaptor.

17. A method for replacing a mounting shoe of a helmet-mounted viewing device having a power inlet with a powered helmet mount adaptor, the method comprising the steps of:
removing a fastener securing the mounting shoe to a fastener element on the viewing device;
providing a powered helmet mount adaptor comprising: (a) a hot shoe assembly having a plurality of electrical contacts structured and operable to receive power via a receiver on an associated helmet mount assembly and; (b) a power cable integral with the hot shoe assembly, the power cable having a first end integral with the hot shoe assembly and a second end opposite the first end, the second end having a connector configured to mate with the power inlet;
securing the hot shoe assembly to the viewing device in place of the mounting shoe using the fastener or a like fastener and the fastener element; and
attaching the connector to the power inlet.

18. The method of claim 17, wherein the hot shoe assembly comprises a hot shoe housing base secured to a hot shoe housing cover and a terminal block intermediate said hot shoe housing base and said hot shoe housing cover, said terminal block having said plurality of electrical contacts thereon, said plurality of electrical contacts configured to electrically couple with aligned electrical contacts on the receiver, and further wherein said step of securing comprises securing the hot shoe housing base to the viewing device using the fastener or a like fastener and the fastener element and then securing the hot shoe housing cover to the hot shoe base.

19. The method of claim 17, wherein the viewing device is a night vision binocular device.

20. The method of claim 19, wherein the viewing device is an AN/PVS-31A night vision binocular device.
